(19) United States
(12) Patent Application Publication
(10) Pub. No.: US 2015/0195234 A1
(43) Pub. Date: Jul. 9, 2015

(54) PREVENTING UNNECESSARY MESSAGES FROM BEING SENT AND RECEIVED

(71) Applicant: International Business Machines Corporation, Armonk, NY (US)

(72) Inventors: Denise A. Bell, Austin, TX (US); Jana H. Jenkins, Raleigh, NC (US); Jeffrey A. Kusnitz, Campbell, CA (US); Sarah R. Plantenberg, San Francisco, CA (US)

(73) Assignee: International Business Machines Corporation, Armonk, NY (US)

(21) Appl. No.: 14/150,476

(22) Filed: Jan. 8, 2014

(51) Int. Cl. H04L 12/58

(52) U.S. Cl. CPC H04L 51/18; H04L 51/24

(57) ABSTRACT

A method, system and computer program product for preventing unnecessary messages (e.g., e-mails) from being sent and received. Recipients designated by an author to receive a message are identified. A time constraint associated with a timeframe to complete a task discussed in the message (e.g., “prepare a report in 3 days”) is obtained. The availability of the recipients to complete the task within the required time constraint is determined prior to the author sending the message. If one of the recipients is unavailable to complete the task within the required time constraint, then the author is informed as such thereby providing the author an opportunity to not send that message to the unavailable recipient. As a result, an unnecessary message is prevented from being sent and received thereby reducing the amount of messages for a user to review.

### TECHNICAL FIELD

The present invention relates generally to electronic messaging systems, and more particularly to preventing unnecessary messages (e.g., e-mails, instant messages, short message service messages) from being sent and received.

### BACKGROUND

Electronic messaging, which includes electronic mail (or “e-mail”) messaging, is now an accepted, and some would say vital, medium for business and personal communications. Currently, users may receive a huge volume of electronic messages making it difficult to manage the quantity of messages, especially when the users are out of the office and are only able to check their messages sporadically. It is not uncommon for users to complain about having to bring a laptop computer with them on their vacation in order to check their messages so that they do not return from vacation with an unreasonable amount of messages to check when they return to the office. Otherwise, the users may have to dedicate hours to sorting, deleting, reading and filing their messages upon their return to the office.

Currently, in an attempt to manage the volume of messages, users may designate certain messages as “junk” signifying that such messages do not need to be read and to be sent to a “junk message” folder. Such messages will not be displayed in the user's “inbox” folder, where the inbox folder is used to store the incoming messages to be viewed by the user. However, users are still receiving an inordinate amount of messages in their inbox folder.

As a result, there is not currently a means for effectively managing the volume of messages being received, such as in the user's inbox folder.

### BRIEF SUMMARY

In one embodiment of the present invention, a method for preventing unnecessary messages from being sent and received comprises identifying one or more recipients to receive a message. The method further comprises obtaining a time constraint to complete a task discussed in the message. The method additionally comprises determining, by a processor, availability of the one or more recipients to complete the task within the time constraint. In addition, the method comprises informing an author of the message that one or more of the one or more recipients are not available to complete the task within the time constraint prior to the author sending the message in response to determining that the one or more of the one or more recipients are unavailable to complete the task within the time constraint.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a communication system configured in accordance with an embodiment of the present invention;

FIG. 2 illustrates a hardware configuration of a client device in accordance with an embodiment of the present invention; and

FIG. 3 is a flowchart of a method for preventing unnecessary messages from being sent and received in accordance with an embodiment of the present invention.

### DETAILED DESCRIPTION

The present invention comprises a method, system and computer program product for preventing unnecessary messages (e.g., e-mails, instant messages, short message service messages) from being sent and received. In one embodiment of the present invention, recipients designated by an author to receive a message are identified. A time constraint associated with a timeframe to complete a task discussed in the message (e.g., “prepare a report in 3 days”) is obtained. The time constraint may be obtained directly from the author of the message or from semantic analysis of the message. The availability of the recipients to complete the task within the required time constraint is determined prior to the author sending the message, such as by checking the calendar of the recipients within the required time constraint or by analyzing an out-of-office notification received from the recipient (e.g., recipient's e-mail client agent). If one of the recipients is not available (i.e., unavailable) to complete the task within the required time constraint, then the author is informed regarding that recipient (and the other recipients, if any, that are unavailable) not being available to complete the task within the time constraint prior to the author sending the message. By informing the author regarding the unavailability of a recipient prior to the author sending the message, the author may decide to not send the message to the recipient as the recipient would not be able to assist the author. As a result, an unnecessary message is prevented from being sent and received thereby reducing the amount of messages for a user to review.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

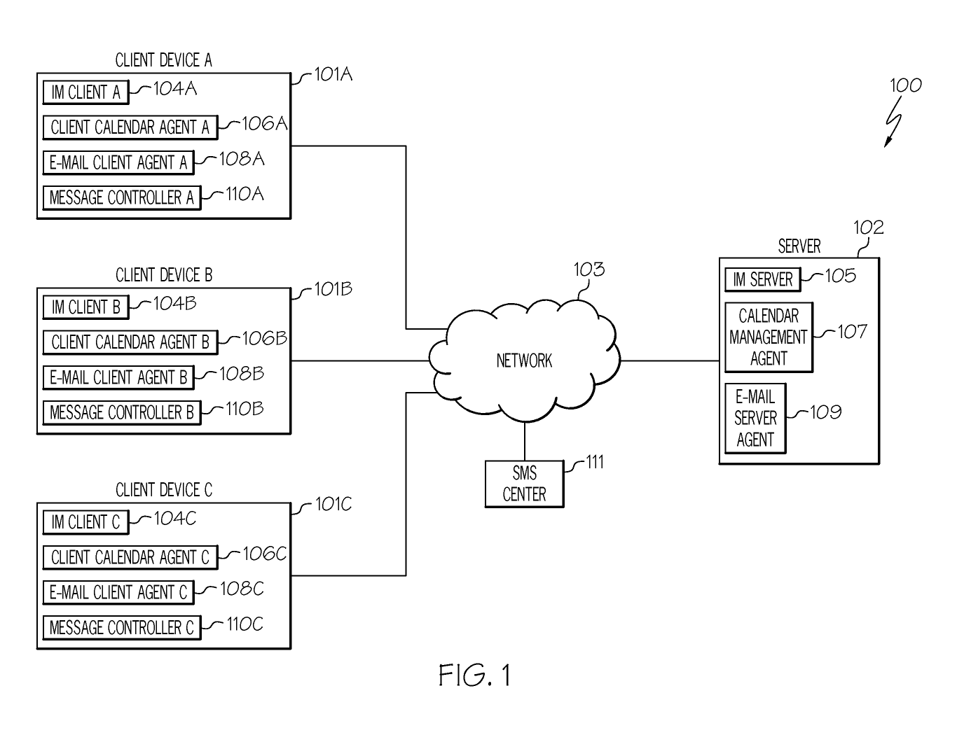

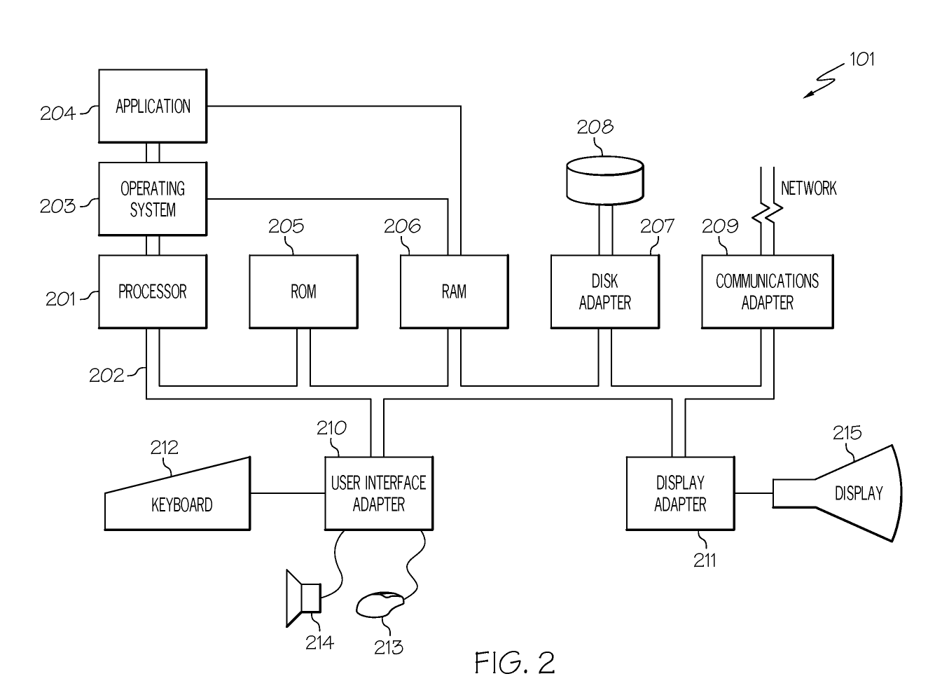

Referring now to the Figures in detail, FIG. 1 illustrates a communication system 100 for practicing the principles of the present invention in accordance with an embodiment of the present invention. Communication system 100 includes client devices 101A-101C (identified as “Client Device A,” “Client Device B,” and “Client Device C,” respectively, in FIG. 1) connected to a server 102 via a network 103. Client devices 101A-101C may collectively or individually be referred to as client devices 101 or client device 101, respectively. Client device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with other client devices 101 and server 102. Client device 101 may be configured to send and receive text-based messages in real-time during an instant messaging session. Any user of client device 101 may be the creator or initiator of an instant message (message in instant messaging) and any user of client device 101 may be a recipient of an instant message. Furthermore, client device 101 may be configured to send out calendar appointments or meeting notices/invitations to other client devices 101 using a calendar application via network 103. Any user of client device 101 may be the creator or initiator of a meeting invitation and any user of client device 101 may be a recipient of a meeting invitation. Additionally, client device 101 may be configured to create, receive and send e-mails. Furthermore, client device 101 may be configured to send and receive text messages, such as Short Message Services (SMS) messages. A description of the hardware configuration of client device 101 is provided below in connection with FIG. 2.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In communication system 100, client devices 101A-101C include a software agent, referred to herein as an “Instant Messaging (IM) client” 104A-104C, respectively. Instant messaging clients 104A-104C may collectively or individually be referred to as instant messaging clients 104 or instant messaging client 104, respectively. Furthermore, server 102 includes a software agent, referred to herein as the “Instant Messaging (IM) server” 105. IM client 104 provides the functionality to send and receive instant messages. As messages are received, IM client 104 presents the messages to the user in a dialog window (or IM window). Furthermore, IM client 104 provides the functionality for client device 101 to connect to the IM server 105 which provides the functionality of distributing the instant messages to the IM clients 104 associated with each of the sharing users.

Client devices 101A-101C may further include a software agent, referred to herein as a “client calendar agent” 106A-106C, respectively. Client calendar agents 106A-106C may collectively or individually be referred to as client calendar agents 106 or client calendar agent 106, respectively. Furthermore, server 102 may include a software agent, referred to herein as the “calendar management agent” 107. Calendar management agent 107 interfaces with client calendar agent 106 to present meeting invitations to client devices 101. Client calendar agent 106 is configured to display the received meeting invitation as well as display calendar schedule information on the client device's 101 calendar user interface.

Furthermore, client devices 101A-101C may include a software agent, referred to herein as an “e-mail client agent” 108A-108C, respectively. E-mail client agents 108A-108C may collectively or individually be referred to as e-mail client agents 108 or e-mail client agent 108, respectively. Furthermore, server 102 may include a software agent, referred to herein as the “e-mail server agent” 109. E-mail client agent 108 enables the user of client device 101 to create, send and receive e-mails. E-mail server agent 109 is configured to receive e-mail messages from client devices 101 and distribute the received e-mail messages among the one or more client devices 101.

While the preceding discusses each client device 101 as including an IM client 104, a client calendar agent 106 and an e-mail client agent 108, each client device 101 may not necessarily include each of these software agents. For example, some client devices 101 may only include an IM client 104; whereas, other client devices 101 may only include a client calendar agent 106 and an e-mail client agent 108. In other words, each client device 101 may be able to perform some or all of the functions discussed herein, such as sending/receiving e-mails, sending/receiving instant messages, sending/receiving text messages, sending/receiving calendar appointments, etc. Furthermore, while the preceding discusses a single server 102 including the software agents, such as IM server 105, calendar management agent 107 and e-mail server agent 109, multiple servers may be used to implement these services. Furthermore, each server 102 may not necessarily be configured to include all of these software agents, but only a subset of these software agents. For example, one particular server 102 may only include IM server 105; whereas, another particular server 102 may only include calendar management agent 107.

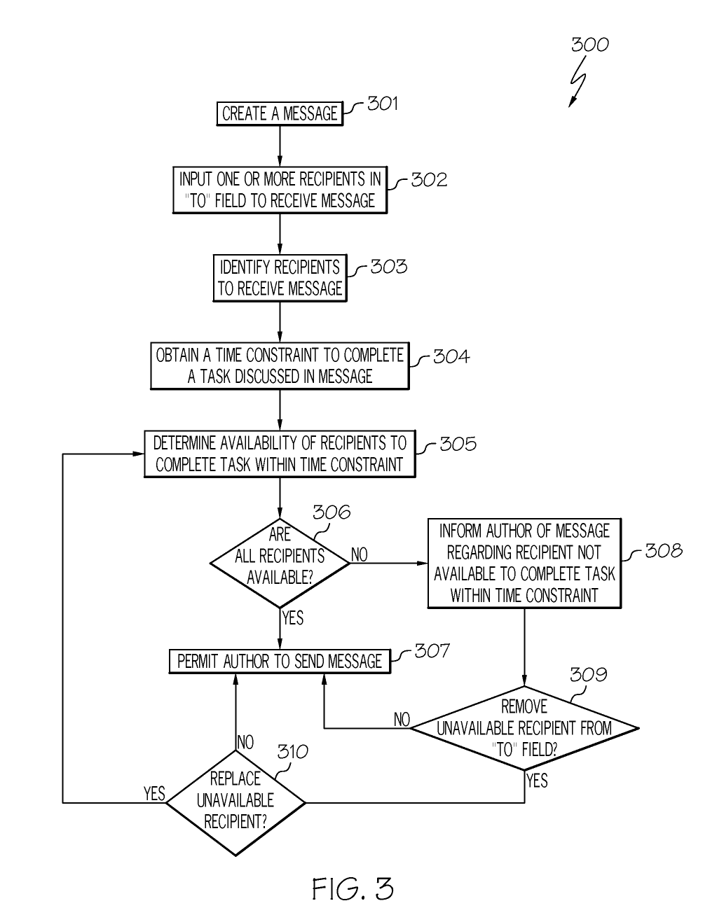

Additionally, client devices 101A-101C include a software agent referred to herein as the “message controller” 110A-110C, respectively, that is configured to manage the volume of messages received by the user of client device 101 by preventing unnecessary messages from being sent and received when a recipient, whether an individual or a group of users, is not able to complete the task discussed in the message within a designated time constraint (e.g., submit report by this Friday) as discussed further below in connection with FIG. 3.

System 100 further includes a Short Message Service (SMC) center 111 configured to relay, store and forward text messages, such as SMS messages, among client devices 101 through network 103.

System 100 is not to be limited in scope to any one particular network architecture. System 100 may include any number of client devices 101, servers 102, networks 103 and SMS centers 110. Furthermore, while message controller 110 is shown as a software agent that resides within client device 101, message controller 101 may reside within another unit, such as server 102, with the capability of identifying the recipients prior to the message (e.g., instant message, e-mail message, SMS message) being sent and determining whether the recipients are available to perform the task discussed in the message within the required time constraint to complete the task.

Referring now to FIG. 2, FIG. 2 illustrates a hardware configuration of client device 101 (FIG. 1) which is representative of a hardware environment for practicing the present invention. Referring to FIG. 2, client device 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, message controller 110 (FIG. 1) configured to manage the volume of messages received by the user of client device 101 by preventing unnecessary messages from being sent and received when a recipient, whether an individual or a group of users, is not able to complete the task discussed in the message within a designated time constraint (e.g., submit report by this Friday) as discussed further below in association with FIG. 3.

Referring again to FIG. 2, read-only memory (“ROM”) 205 is coupled to system bus 202 and includes a basic input/output system (“BIOS”) that controls certain basic functions of client device 101. Random access memory (“RAM”) 206 and disk adapter 207 are also coupled to system bus 202. It should be noted that software components including operating system 203 and application 204 may be loaded into RAM 206, which may be client device's 101 main memory for execution. Disk adapter 207 may be an integrated drive electronics (“IDE”) adapter that communicates with a disk unit 208, e.g., disk drive. It is noted that the program (message controller 110) for managing the volume of messages received by the user of client device 101 by preventing unnecessary messages from being sent and received when a recipient, whether an individual or a group of users, is not able to complete the task discussed in the message within a designated time constraint, as discussed further below in association with FIG. 3, may reside in disk unit 208 or in application 204.

Client device 101 may further include a communications adapter 209 coupled to bus 202. Communications adapter 209 interconnects bus 202 with an outside network (network 103 of FIG. 1) thereby enabling consolidated client device 101 to communicate with other client devices 101, server 102 and SMS center 111.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As stated in the Background section, electronic messaging, which includes electronic mail (or “e-mail”) messaging, is now an accepted, and some would say vital, medium for business and personal communications. Currently, users may receive a huge volume of electronic messages making it difficult to manage the quantity of messages, especially when the users are out of the office and are only able to check their messages sporadically. It is not uncommon for users to complain about having to bring a laptop computer with them on their vacation in order to check their messages so that they do not return from vacation with an unreasonable amount of messages to check when they return to the office. Otherwise, the users may have to dedicate hours to sorting, deleting, reading and filing their messages upon their return to the office. Currently, in an attempt to manage the volume of messages, users may designate certain messages as “junk” signifying that such messages do not need to be read and to be sent to a “junk message” folder. Such messages will not be displayed in the user's “inbox” folder, where the inbox folder is used to store the incoming messages to be viewed by the user. However, users are still receiving an inordinate amount of messages in their inbox folder. As a result, there is not currently a means for effectively managing the volume of messages being received, such as in the user's inbox folder.

The principles of the present invention provide a means for managing the volume of messages being sent/received by preventing unnecessary messages from being sent/received as discussed below in connection with FIG. 3.

FIG. 3 is a flowchart of a method 300 for preventing unnecessary messages from being sent and received in accordance with an embodiment of the present invention.

Referring to FIG. 3, in conjunction with FIGS. 1-2, in step 301, an author, such as the user of client device 101 (e.g., user of client device 101A) creates a message (e-mail message, instant message, SMS message).

In step 302, the author inputs one or more recipients, such as in the “TO” field, to receive the message. “Recipient,” as used herein, includes both individuals as well as a group of individuals. While FIG. 3 illustrates step 302 being performed following step 301, it is noted that step 302 may be performed prior to step 301, such as in an IM application, where the application selects the recipient to instant message prior to creating the message.

In step 303, message controller 110 identifies the recipients to receive the message.

In step 304, message controller 110 obtains a time constraint to complete a task discussed in the message. The “time constraint,” as used herein, refers to the duration of time that the recipient has to complete the task (e.g., next three days). The time constraint may be obtained directly from the author of the message. For example, the author may input that the task discussed in the message is to be completed within the next three days. Alternatively, the time constraint may be obtained by performing a semantic analysis of the message, such as using natural language processing, to determine the deadline to complete the task discussed in the message. For example, in the message, “prepare a report in 3 days,” the time constraint is three days to complete the report.

In one embodiment, the message specifically includes the time constraint to complete the task, such as in the example discussed above. In another embodiment, the message may only designate a task to complete without specifically stating a deadline. For instance, in the message “prepare presentation,” the task is to prepare a presentation. However, the message does not specifically state a designated deadline. The author may input a deadline to complete the task thereby providing message controller 110 with a time constraint to complete the task. In another example, the message may state “prepare presentation as quickly as possible.” In such a scenario, a definitive deadline is not provided. Hence, the author may be requested to provide a more definitive deadline (if not already providing the time constraint) to thereby assist message controller 110 in determining the availability of the recipients in completing the task within the required timeframe as discussed below.

In step 305, message controller 110 determines the availability of the recipients to complete the task within the required time constraint (i.e., the required timeframe). In one embodiment, message controller 110 determines the availability of the recipients by checking the calendar of the recipients within the required time constraint. In one embodiment, message controller 110 may check the calendar of a recipient by communicating with the recipient's client calendar agent 106 to access the recipient's calendar. Message controller 110 may then utilize semantic analysis, such as using natural language processing, to identify keywords or phrases, such as “traveling to England.” In another embodiment, message controller 110 determines the availability of the recipients by detecting an out-of-office notification from the recipient. For example, message controller 110 may communicate with the recipient's e-mail client agent 108 to determine if the recipient has established an automatic reply to messages, and if so, what is the content of the automatic reply. For example, the recipient may have an out-of-office notification that indicates that the recipient is on vacation over a designated period of time. In another example, the recipient may have an out-of-office notification that indicates that the recipient will be working on a client site with limited access to e-mail. Message controller 110 may utilize semantic analysis on the out-of-office notification to determine the availability of the recipient.

In step 306, a determination is made by message controller 110 as to whether each of the recipients inputted by the author in step 302 is available to perform the task designated in the message within the required time constraint.

If all of the recipients are available, then, in step 307, message controller 110 permits the author to send the message to the designated recipients.

If one of the recipients is not available (i.e., unavailable) to complete the task within the required time constraint, then, in step 308, message controller 110 informs the author regarding that recipient (and the other recipients, if any, that are unavailable) not being available to complete the task within the time constraint prior to the author sending the message. For example, message controller 110 may inform the author of the message that the recipient has an out-of-office notification that indicates that the recipient will be out of the country for the next week. In another example, message controller 110 may inform the author of the message that the recipient has an out-of-office notification that indicates that the recipient will have limited access to e-mail during the next three days. In a further example, message controller 110 may inform the author of the message that the recipient has blocked off the next two days in his/her calendar indicating that the recipient will be attending a company retreat.

By informing the author regarding the unavailability of a recipient prior to the author sending the message, the author may decide to not send the message to the recipient as the recipient would not be able to assist the author. As a result, an unnecessary message is prevented from being sent and received thereby reducing the amount of messages for a user to review.

For each unavailable recipient, in step 309, a determination is made by message controller 110 as to whether the author removed the unavailable recipient, such as removing the unavailable recipient from the “TO” field of the message.

If the author does not remove the unavailable recipient, such as removing the unavailable recipient from the “TO” field of the message, then message controller 110 permits the author to send the message to that unavailable recipient in step 307.

If, however, the author removes the unavailable recipient, such as removing the unavailable recipient from the “TO” field of the message, then, in step 310, a determination is made by message controller 110 as to whether the author replaced the unavailable recipient with another recipient. An author may decide to replace the unavailable recipient with an alternative recipient who may be able to assist the author in completing the assigned task.

If the author did not replace the unavailable recipient with another recipient, then message controller 110 permits the author to send the message to the other available recipients in step 307.

If, however, the author replaced the unavailable recipient with another recipient, then message controller 110 determines the availability of the replacement recipient to complete the task within the required time constraint (i.e., the required timeframe) in step 305.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-6. (canceled)

7. A computer program product embodied in a computer readable storage medium for preventing unnecessary messages from being sent and received, the computer program product comprising the programming instructions for:
identifying one or more recipients to receive a message;
obtaining a time constraint to complete a task discussed in said message;
determining availability of said one or more recipients to complete said task within said time constraint; and
informing an author of said message that one or more of said one or more recipients are not available to complete said task within said time constraint prior to said author sending said message in response to determining that said one or more of said one or more recipients are unavailable to complete said task within said time constraint.

8. The computer program product as recited in claim 7 further comprising the programming instructions for:
receiving said time constraint to complete said task from said author.

9. The computer program product as recited in claim 7 further comprising the programming instructions for:
performing a semantic analysis of said message to determine said time constraint to complete said task.

10. The computer program product as recited in claim 7 further comprising the programming instructions for:
determining availability of one or more recipients to complete said task within said time constraint who have replaced said one or more of said one or more recipients who are not available to complete said task.

11. The computer program product as recited in claim 7, wherein said message is one of the following: an electronic message, a short message service message and an instant message.

12. The computer program product as recited in claim 7, wherein said availability of said one or more recipients is determined based on one or more of the following: an out-of-office notification and a calendar entry.

13. A system, comprising:
a memory unit for storing a computer program for preventing unnecessary messages from being sent and received; and
a processor coupled to said memory unit, wherein said processor, responsive to said computer program, comprises:
circuitry for identifying one or more recipients to receive a message;
circuitry for obtaining a time constraint to complete a task discussed in said message;
circuitry for determining availability of said one or more recipients to complete said task within said time constraint; and
circuitry for informing an author of said message that one or more of said one or more recipients are not available to complete said task within said time constraint prior to said author sending said message in response to determining that said one or more of said one or more recipients are unavailable to complete said task within said time constraint.

14. The system as recited in claim 13, wherein said processor further comprises:
receiving said time constraint to complete said task from said author.

15. The system as recited in claim 13, wherein said processor further comprises:
performing a semantic analysis of said message to determine said time constraint to complete said task.

16. The system as recited in claim 13, wherein said processor further comprises:
determining availability of one or more recipients to complete said task within said time constraint who have replaced said one or more of said one or more recipients who are not available to complete said task.

17. The system as recited in claim 13, wherein said message is one of the following: an electronic message, a short message service message and an instant message.

18. The system as recited in claim 13, wherein said availability of said one or more recipients is determined based on one or more of the following: an out-of-office notification and a calendar entry.
